(19) United States
(12) Patent Application Publication
(10) Pub. No.: US 2020/0283648 A1
(43) Pub. Date: Sep. 10, 2020

(54) ELECTRONIC DEVICE HOUSINGS WITH WATERBORNE METALLIC PAINT COATINGS

(71) Applicant: HEWLETT-PACKARD DEVELOPMENT COMPANY, L.P., SPRING, TX (US)

(72) Inventors: KUAN-TING WU, TAIPEI CITY (TW); YA-TING YEH, TAIPEI CITY (TW); CHI HAO CHANG, TAIPEI CITY (TW)

(21) Appl. No.: 16/754,122

(22) PCT Filed: Nov. 13, 2017
(86) PCT No.: PCT/US2017/061211

§ 371 Date: Apr. 6, 2020

(51) Int. Cl. C09D 7/62; C09D 5/10; C09D 7/40; H01Q 1/42

(52) U.S. Cl. CPC C09D 7/62; C09D 5/10; C08K 3/346; H01Q 1/421; C09D 7/70

(57) ABSTRACT

In one example, an electronic device housing is described, which may include a substrate having a surface and at least one waterborne metallic paint coating formed on the surface of the substrate. The at least one waterborne metallic paint coating may include an insulating material encapsulated metal powder in combination with at least one of a surface modified synthetic mica and a surface modified glass platelet.

### BACKGROUND

Electronic devices such as notebook computers, tablet computers, mobile phones, and the like may include housings to house various electronic components. To make the electronic devices fashionably and aesthetically appealing to users, decorative metallic-appearing coatings may be formed on housings of electronic devices. The metallic-appearing coatings may also provide a metallic-appearance. Metallic-appearing coatings may include significant amount of metal powder such as aluminum flakes.

### BRIEF DESCRIPTION OF THE DRAWINGS

Examples are described in the following detailed description and in reference to the drawings, in which:

FIG. 1 illustrates a schematic representation of an example electronic device housing having a waterborne metallic paint coating on a top surface;

FIG. 2A illustrates a schematic representation of an example insulating material encapsulated metal powder that is used in formulation of the waterborne metallic paint coating;

FIG. 2B illustrates a schematic representation of n example surface modified synthetic mica that is used in the formulation of the waterborne metallic paint coating;

FIG. 2C illustrates a schematic representation of an example surface modified glass platelet that is used in the formulation of the waterborne metallic paint coating;

FIG. 3 illustrates a cross-sectional side-view of an example electro device;

FIG. 4A illustrates a schematic representation of an example electronic device housing, depicting a 2-layer waterborne metallic paint coating on a metal/plastic substrate;

FIG. 4B illustrates a schematic representation of an example electronic device housing, depicting a waterborne metallic paint coating and a water-based primer coating on the metal/plastic substrate;

FIG. 5 illustrates a schematic representation of an example electronic device housing, depicting a 2-layer waterborne metallic paint coating and a waterborne primer coating on a carbon fiber composite substrate;

FIG. 6A illustrates a schematic representation of an example electronic device housing, depicting a 2-layer waterborne metallic paint coating, and a powder coating on a forged/die casted/computer numeric control (CNC) machined metal substrate;

FIG. 6B illustrates a schematic representation of an example electronic device housing, depicting a waterborne clear top coating applied on the waterborne metallic paint coating;

FIGS. 7A-7D illustrate schematic representations of example electronic device housings, depicting at least one waterborne metallic paint coating in combination with a micro-arc oxidation (MAO) layer on the metal substrate;

FIGS. 8A-8C illustrate schematic representations of example electronic device housings, depicting at least one waterborne metallic paint coating in combination with a passive layer on the metal substrate;

FIG. 9A illustrates an example process for manufacturing an electronic device housing; and

FIG. 9B illustrates the example process for manufacturing the electronic device housing of FIG. 9A, depicting additional features.

### DETAILED DESCRIPTION

Decorative metallic-appearing coatings may be formed on housings of electronic devices. The metallic-appearing coatings may also provide a metallic luster. Metallic-appearing coatings may involve significant amount of metal powder such as aluminum flakes. Such metallic-appearing coatings may shield antenna radiation performance of the electronic devices. Further, the metal powder may not be suitable for water-based paint formulation due to a corrosion risk of the metallic-appearing coatings and poor bonding at an interface of the metal powder and water-based binders. In addition, metallic-appearing coatings may involve solvent-based paint formulation, which can cause volatile organic compound (VOC) emission issues. Solvent-based metallic-appearing coatings on substrates may have the VOC emission issues, which can affect the health of people working in such painting environments.

Examples described herein may provide an electronic device housing having a substrate and a waterborne metallic paint coating formed on a surface of the substrate. The waterborne metallic paint coating may include an insulating material (e.g., polymer resin, silicon dioxide, and the like) encapsulated metal powder (e.g., aluminum flakes) in combination with at least one of a surface modified synthetic mica and a surface modified glass platelet.

Examples described herein may enhance metallic lustering of the electronic device housing by internal light scattering through high brightness/transmittance glass platelets, high transparent synthetic mica, and/or polymer resin/silicon dioxide encapsulated aluminum flakes. Examples described herein may resolve antenna radiation shielding issues while maintaining metallic luster surface finish on the electronic device housings (e.g., cover surfaces) without corrosion risk of the metallic-appearing coatings and/or poor bonding at the interface of the metal powder and water-based binders. Examples described may eliminate/reduce the VOC emission issues by utilization of waterborne metallic paint coatings on substrates. Furthermore, examples described herein may provide a green product solution and offer an environment friendly process.

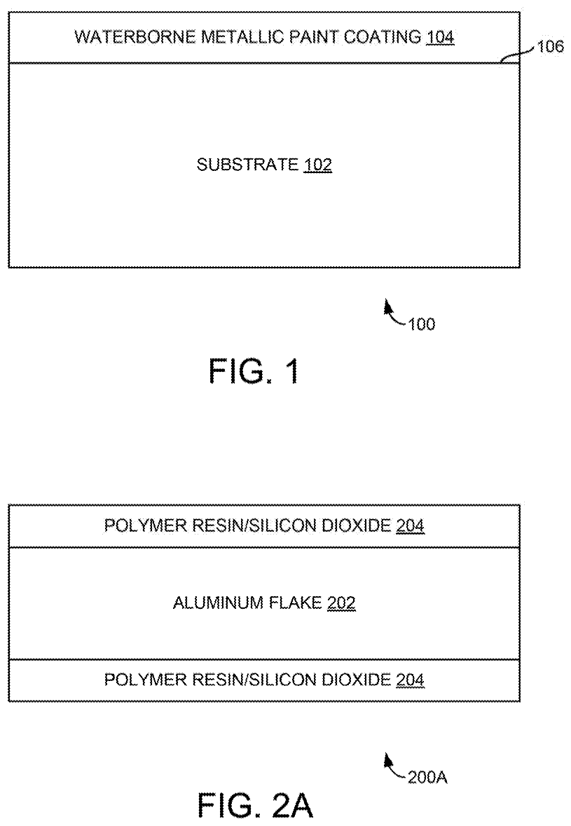

FIG. 1 illustrates a schematic representation of an example electronic device housing 100 having a waterborne metallic paint coating 104 on a top surface. Example electronic device housing 100 may be a housing of a mobile phone, personal digital assistant (PDA), notebook computer, tablet computer, MP3, MP4, global positioning system (GPS) navigator, digital camera, convertible device, a personal gaming device, or the like. Electronic device housing 100 may include a substrate 102 having a surface 106. Example substrate 102 may be made of plastic, metal, carbon fiber composite, or any combination thereof. In other examples, substrate 102 may be made of glass or ceramic.

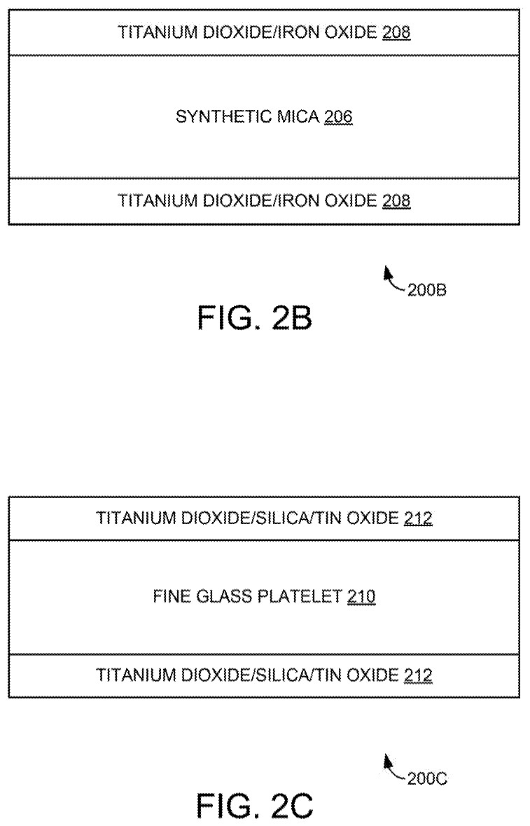

Further, electronic device housing 100 may include at least one waterborne metallic paint coating 104 formed on surface 106 of substrate 102. For example, waterborne metallic paint coating 104 may have a thickness of about 10-25 μm. In one example, waterborne metallic paint coating 104 may include an insulating material encapsulated metal powder in combination with at least one of a surface modified synthetic mica and a surface modified glass platelet in the formulation. Example formulation of waterborne metallic paint coating 104 is explained in FIGS. 2A-2C.

FIG. 2A illustrates a schematic representation of an example insulating material encapsulated metal powder 200A that is used in the formulation of waterborne metallic paint coating 104, Example metal powder 202 may include aluminum flakes. Example insulating material 204 may include at least one of polymer resin and silicon dioxide. Insulating material 204 may have a thickness of about 20-80 nm. In one example, polymer resin/silicon dioxide 204 encapsulated aluminum flakes 202 may make the surface of aluminum flakes 202 electrically insulated.

FIG. 2B illustrates a schematic representation of an example surface modified synthetic mica 2008 that is used in the formulation of waterborne metallic paint coating 104. In one example, surface modified synthetic mica 2008 may include a synthetic mica 206 coated with a first metallic-appearing coating 208. Example synthetic mica 206 may be fluorphlogopite. Example first metallic-appearing coating 208 may be selected from a group consisting of titanium dioxide and iron oxide.

Further, surface modified synthetic mica 200B may have a color appearance selected from a group consisting of silver, gold, red, blue, green, bronze, copper, and russet. The color appearance on synthetic mica 206 may depend on a thickness of first metallic-appearing coating 208. For example, the thickness of first metallic-appearing coating 208 may be about 10-160 nm, specifically about 10-60 nm.

FIG. 2C illustrates a schernatic representation of an example surface modified glass platelet 200C that is, used in the formulation of waterborne metallic paint coating 104. In one example, surface modified glass platelet 200C may include a fine glass platelet 210 coated with a second metallic-appearing coating 212 having less diffuse scattering effect. Fine glass platelet 210 may be a high brightness and high whiteness glass platelet. Example fine glass platelet 210 may include calcium sodium borosilicate flakes. In one example, second metallic appearing coating 212 may be selected from a group consisting of titanium dioxide, silica, and tin oxide. Second metallic-appearing coating 212 may have a thickness of about 10-160 nm, specifically about 10-60 nm. For example, titanium dioxide coated synthetic mica and glass platelet may enhance whiteness of painting layer and improve blue shade appearance to resolve yellowness issues on the top surface of electronic device housing 100.

Thus, examples described in FIGS. 1 and 2A-2C may develop waterborne metallic paint coating 104 using polymer resin or silicon dioxide encapsulated metal powder in combination with high whiteness surface modified synthetic mica, and/or high brightness and high whiteness surface modified fine glass platelets. Waterborne metallic paint coating 104 may resolve the antenna radiation shielding issue and maintain the metallic luster surface finish on surface 106 of electronic device housing 100 without painting layer corrosion risk and poor bonding at the interface of metal powder and water-based binders.

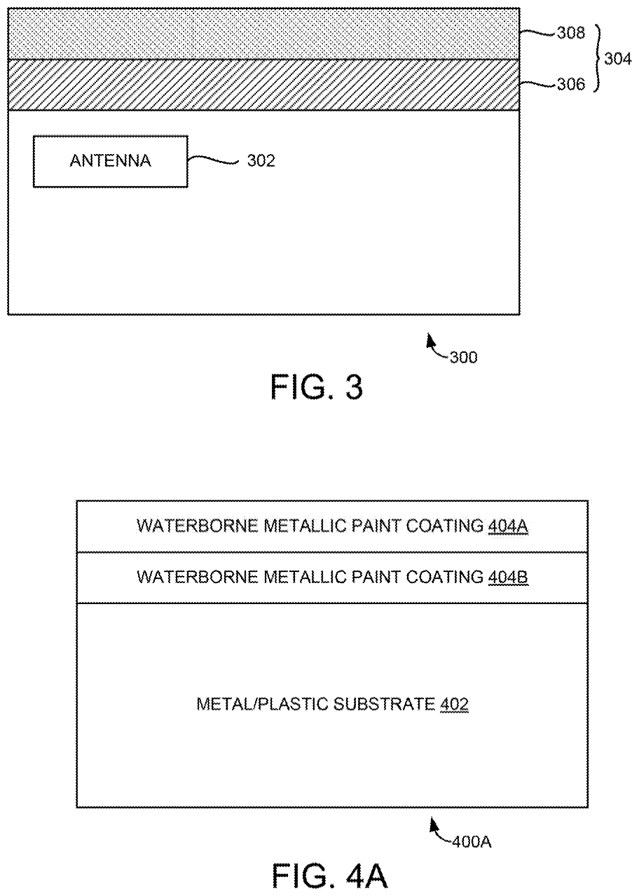

FIG. 3 illustrates a cross-sectional side-view of an example electronic device 300. Example electronic device 300 may be a computing system, for example, a mobile phone, personal digital assistant (PDA), notebook computer, tablet computer, MP3, MP4, global positioning system (GPS) navigator, digital camera, convertible device, a personal gaming device, or the like. Example convertible device may refer to a device that can be “converted” from a laptop mode to a tablet mode. In some examples, electronic device 300 may include a first housing and a second housing rotatably, detachably or twistably connected to the first housing. Examples described herein can be implemented in the first housing, second housing, or a combination thereof.

Example electronic device 300 may include at least one antenna 302 and a housing 304 to house at least one antenna 302. For example, antenna 302 may include an antenna with resonating elements that are formed from loop antenna structures, patch antenna structures, inverted-F antenna structures, slot antenna structures, planar inverted-F antenna structures, helical antenna structures, hybrids of these designs, and the like. Different types of antennas may be used for different bands and combinations of bands. For example, one type of antenna may be used in forming a local wireless link antenna and another type of antenna may be used in forming a remote wireless link antenna.

In some examples, housing 304 may house a display (e.g., a touchscreen display). Example display may include liquid crystal display (LCD), light emitting diode (LED), electro-luminescent (EL) display, or the like. Electronic device 300 may be equipped with other components such as a camera, audio/video devices, and the like, depending on the functions of electronic device 300.

Housing 304 may include a substrate 306 and at least one waterborne metallic paint coating 308 formed on a surface of substrate 306 to allow transmission and/or reception of antenna signals. Waterborne metallic paint coating 308 may be applied as a non-impact antenna coating on substrate 306. For example, waterborne metallic paint coating 308 formed on substrate 306 can be nonconductive to not block electromagnetic waves. For example, substrate 306 may be made of plastic, metal, glass, or carbon fiber composite. Example waterborne metallic paint coating 308 may include an insulating material encapsulated metal powder in combination with at least one of a surface modified synthetic mica and a surface modified glass platelet.

In another example, housing 304 may include a waterborne clear top coating formed on a top surface of at least one waterborne metallic paint coating 308. In one example, waterborne clear top coating may be a glossy and transparent coating that forms the final interface with the environment. Waterborne clear top coating may withstand ultraviolet light. In some examples, waterborne clear top coating can be applied on waterborne metallic paint coating 308 as a spray coat. In yet another example, housing 304 may include at least one intermediate coating formed between substrate 306 and at least one waterborne metallic paint coating 308. The intermediate coating may be selected from a group consisting of a waterborne primer coat, a powder coat, a micro-arc oxidation (MAO) layer, and a passive layer. Each intermediate coating may have a thickness of about 50 nm-60 μm depending on a type of the intermediate coating.

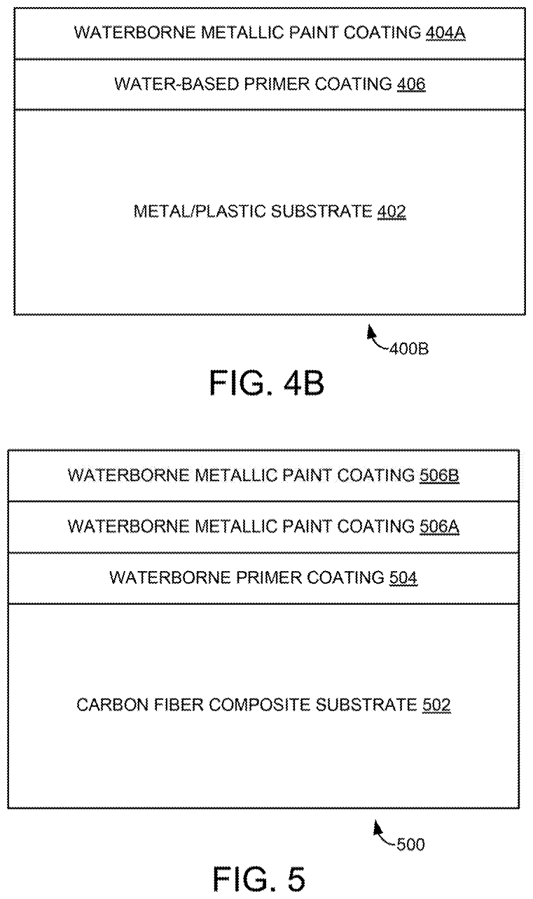

For example, the intermediate coating may have a smooth surface for enhancing bonding between substrate 306 and waterborne metallic paint coating 308 or subsequent coatings. In some examples, intermediate coatings can be omitted, and at least one waterborne metallic paint coating 308 can be directly formed on substrate 306. Example intermediate coatings and the waterborne dear top coating may be explained in FIGS. 4-8.

FIG. 4A illustrates a schematic representation of an example electronic device housing 400A, depicting a 2-layer waterborne metallic paint coating 404A and 404B on a metal/plastic substrate 402. Waterborne metallic paint coatings 404A and 404B may contain a polymer resin encapsulated aluminum powder, silicon dioxide coated metal powder, high whiteness surface modified synthetic mica and/or high brightness and high whiteness surface modified fine glass platelets in the formulation. Further, each waterborne metallic paint coating 404A and 404B may have a thickness of about 10-25 μm.

FIG. 4B illustrates a schematic representation of an example electronic device housing 400B, depicting a waterborne metallic paint coating 404A and a water-based primer coating 406 on metal/plastic substrate 402. In this example, water-based primer coating 406 may be an intermediate coating with a thickness of about 5-20 μm and formed between metallic/plastic substrate 402 and waterborne metallic paint coating 404A. Water-based primer coating 406 may be used as a bonding agent between waterborne metallic paint coating 404A and metallic/plastic substrate 402. Alternatively, water-based primer coating 406 may be omitted to directly apply waterborne metallic paint coating 404A on metallic/plastic substrate 402.

FIG. 5 illustrates a schematic representation of air example electronic device housing 500, depicting a 2-layer waterborne metallic paint coating 506A and 506B and a waterborne primer coating 504 on a carbon fiber composite substrate 502, In this example, waterborne primer coating 504 may be an intermediate coating with a thickness of about 10-30 μm and formed between carbon fiber composite substrate 502 and waterborne metallic paint coating 506A. Each waterborne metallic paint coating 506A and 506B may have a thickness of about 10-25 μm.

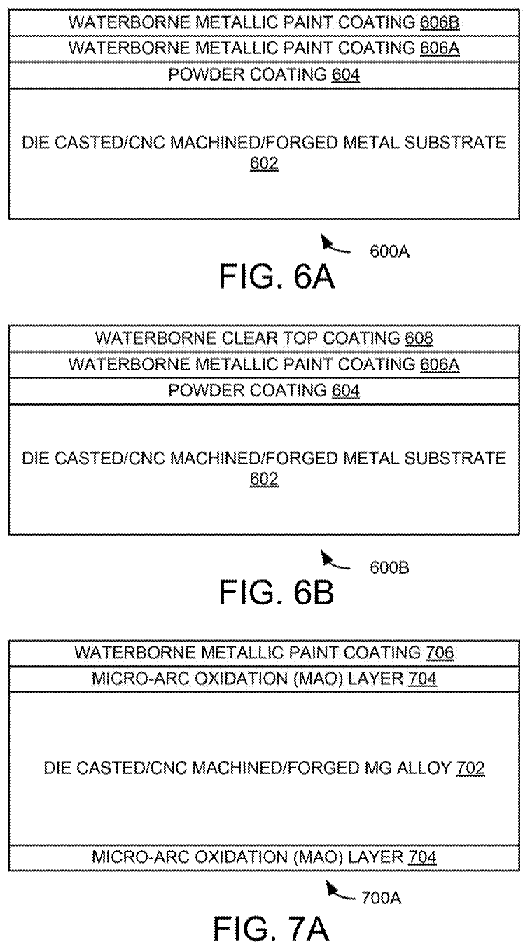

FIG. 6A illustrates a schematic representation of an example electronic device housing 600A, depicting a 2-layer waterborne metallic paint coating 606A and 6068 and a powder coating 604 on a forged/die casted/computer numeric control (CNC) machined metal substrate 602. In one example, metal substrate 602 may be formed into a desired shape by forging, die casting or CNC machining. In this example, powder coating 604 may be an intermediate coating with a thickness of about 20-60 μm.

Powder coating 604 may refer to a process of coating metal substrate 602 with a plastic finish applied in powder form and baked to, a fluid state to bond powder coating 604 to a surface of metal substrate 602. Powder coating 604 contain no solvents and release little or no amount of VOC into the atmosphere. Further, powder coating 604 may produce significantly thicker coatings than liquid coatings.

FIG. 6B illustrates a schematic representation of an example electronic device housing 600B, depicting a waterborne clear top coating 608 applied on a top surface of waterborne metallic paint coating 606A. Particularly, FIG. 6B illustrates powder coating 604 formed on a forged/die casted/CNC machined metal substrate 602, waterborne metallic paint coating 606A formed on powder coating 604, and waterborne clear top coating 608 applied on waterborne metallic paint coating 606A. In other examples, waterborne clear top coating 608 can also be applied on a top surface of a 2-layer waterborne metallic paint coating. For example, waterborne clear top coating 608 may have a thickness of about 10-25 μm.

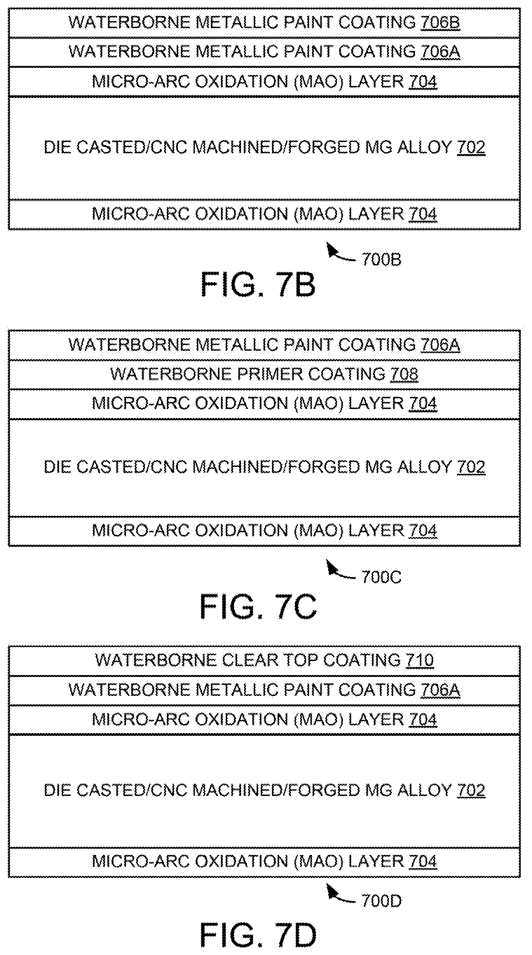

FIGS. 7A-7D illustrate schematic representations of example electronic device housings 700A-700D, depicting at least one waterborne metallic paint coating 706 in combination with an MAO layer 704 on metal substrate 702. Example metal substrate 702 may be a forged/die casted/CNC machined magnesium alloy. As shown in FIGS. 7A-7C, MAO layer 704 may be formed on opposite surfaces of metal substrate 702. For example, MAO layer 704 may be formed on metal substrate 702 using an MAO process, which may be an electrochemical surface treatment process for generating oxide coatings on metals. Micro-arc oxidized metal substrate 702 may include properties such as wearing resistance, corrosion resistance, high hardness and electrical insulation.

FIG. 7A depicts MAO layer 704 formed on metal substrate 702 and a layer of waterborne metallic paint coating 706 formed on MAO layer 704. In the example shown in FIG. 7A, MAO layer 704 may have a thickness of about 2-15 μm and waterborne metallic paint coating 706 may have a thickness of about 10-25 μm. FIG. 7B depicts MAO layer 704 formed on metal substrate 702 and 2-layers of waterborne metallic paint coatings 706A and 706B formed on MAO layer 704. In the example shown in FIG. 7B, MAO layer 704 may have a thickness of about 2-10 μm and each waterborne metallic paint coating 706A and 706B may have a thickness of about 10-25 μm.

FIG. 7C depicts MAO layer 704 formed on metal substrate 702, waterborne primer coating 708 formed on MAO layer 704, and a layer of waterborne metallic paint coating 706A formed on waterborne primer coating 708. In the example shown in FIG. 7C, MAO layer 704 may have a thickness of about 2-15 μm, waterborne primer coating 708 may have a thickness of about 5-20 μm, and waterborne metallic paint coating 706A may have a thickness of about 10-25 μm.

FIG. 70 depicts MAO layer 704 formed on metal substrate 702, waterborne metallic paint coating 706A formed on MAO layer 704, and waterborne clear top coating 710 formed on waterborne metallic paint coating 706A. In the example shown in FIG. 7D, MAO layer 704 may have a thickness of about 2-15 μm, waterborne metallic paint coating 706A may have a thickness of about 10-25 μm, and waterborne clear top coating 710 may have a thickness of about 10-25 μm.

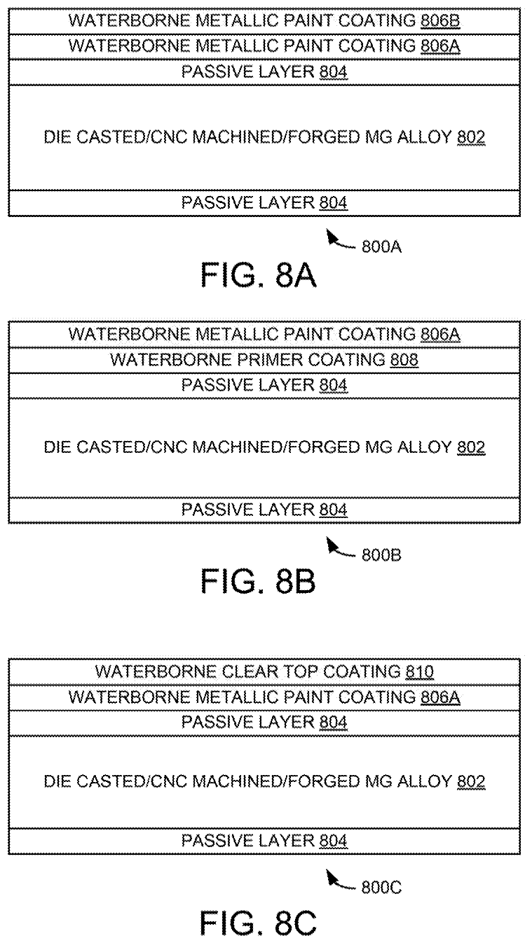

FIGS. 8A-8C illustrate schematic representations of example electronic device housings 800A-800C, depicting at least one waterborne metallic paint coating 806 in combination with a passive layer 804 on opposite surfaces of metal substrate 802. Example metal substrate 802 may be a forged/die casted/CNC machined magnesium alloy. Passive layer 804 may involve creation of an outer layer of shield material around metal substrate 802 to make metal substrate 802 “passive”, i.e., less affected or corroded by the environment

FIG. 8A depicts passive layer 804 formed on metal substrate 802 and 2-layers of waterborne metallic paint coatings 806A and 8068 formed on passive layer 804. In the example shown in FIG. 8A, passive layer 804 may have a thickness of about 50 nm-1 μm and each waterborne metallic paint coating 806A and 8068 may have a thickness of about 10-25 μm.

FIG. 8B depicts passive layer 804 formed on metal substrate 802, waterborne primer coating 808 formed on passive layer 804, and a layer of waterborne metallic paint coating 806A formed on waterborne primer coating 808. In the example shown in FIG. 8B, passive layer 804 may have a thickness of about 50 nm-1 μm, waterborne primer coating 808 may have a thickness of about 5-20 μm, and waterborne metallic paint coating 806A may have a thickness of about 10-25 μm.

FIG. 8C depicts passive layer 804 formed on metal substrate 802, waterborne metallic paint coating 806A formed on passive layer 804, and waterborne clear top coating 810 formed on waterborne metallic paint coating 806A. In the example shown in FIG. 8C, passive layer 804 may have a thickness of about 50 nm-1 μm, waterborne metallic paint coating 806A may have a thickness of about 10-25 μm, and waterborne clear top coating 810 may have a thickness of about 10-25 μm. Waterborne paints described in FIGS. 1-8 can reduce 69% to 93% VOC emission on waterborne topcoat, basecoat, or primer in comparison with solvent-borne liquid paints.

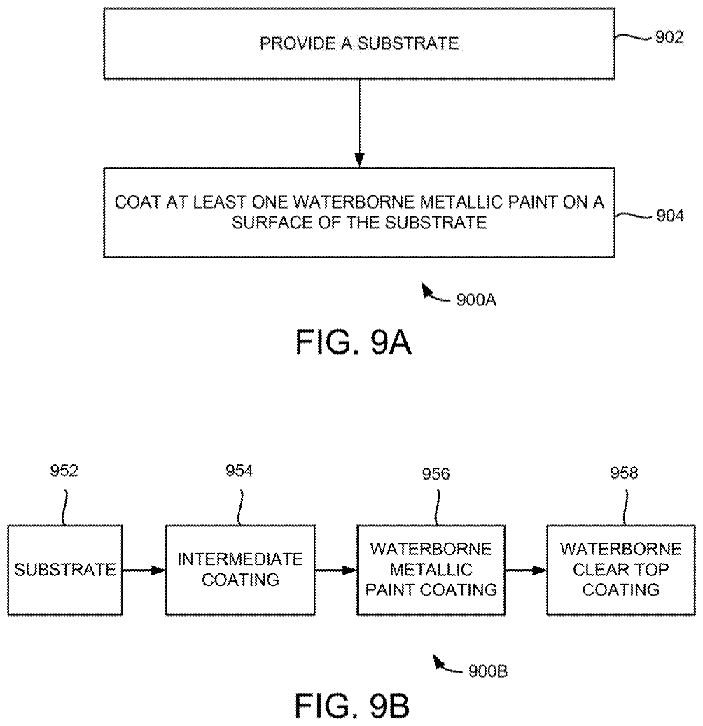

FIG. 9A illustrates an example process 900A for manufacturing an electronic device housing. At 902, a substrate may be provided. In one example, the substrate may be formed into a desired shape by forging, die casting or CNC machining. In another example, the substrate may be formed into the desired shape using a superplastic forming process. At 904, at least one waterborne metallic paint may be coated on a surface of the substrate. In one example, the waterborne metallic paint may be formed of an insulating material encapsulated metal powder in combination with at least one of a surface modified synthetic mica and a surface modified glass platelet.

FIG. 9B illustrates the example process for manufacturing the electronic device housing of FIG. 9A, depicting additional processes At 952, a substrate may be provided. At 954, at least one intermediate coating may be formed on a surface of the substrate. Example intermediate coating may be selected from a group consisting of a waterborne primer coat, a powder coat, an MAO layer, and a passive layer. At 956, at least one waterborne metallic paint may be coated on the at least one intermediate coating.

In one example, prior to coating the at least one waterborne metallic paint on the surface of the substrate, the surface of the substrate may be coated with one of a waterborne primer coat, a powder coat, an MAO layer, and a passive layer.

In another example, prior to coating the at least one waterborne metallic paint on the surface of the substrate, an MAO layer may be formed on the surface of the substrate and a waterborne primer may be coated on the formed MAO layer of the substrate.

In yet another example, prior to coating the at least one waterborne metallic paint on the surface of the substrate, a passive layer may be formed on the surface of the substrate and a waterborne primer may be coated on the formed passive layer of the substrate. Alternatively, at least one waterborne metallic paint coating can be directly coated on the substrate without any intermediate coatings. In addition, a waterborne clear top coat can be directly coated on waterborne metallic paint coating, at 958.

It may be noted that the above-described examples of the present solution are for the purpose of illustration only. Although the solution has been described in conjunction with a specific implementation thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. An electronic device housing, comprising:
a substrate having a surface; and
at least one waterborne metallic paint coating formed on the surface of the substrate, wherein the at least one waterborne metallic paint coating comprises:
an insulating material encapsulated metal powder in combination with at least one of a surface modified synthetic mica and a surface modified glass platelet.

2. The electronic device housing of claim 1, wherein each of the at least one waterborne metallic paint coating has a thickness of about 10-26 μm.

3. The electronic device housing of claim 1, wherein the metal powder comprises aluminum flakes, wherein the insulating material comprises at least one of polymer resin and silicon dioxide, and wherein the insulating material has a thickness of about 20-80 nm.

4. The electronic device housing of claim 1, wherein the surface modified synthetic mica comprises a synthetic mica coated with a first metallic-appearing coating, and wherein the first metallic-appearing coating is selected from a group consisting of titanium dioxide and iron oxide.

5. The electronic device housing of claim 4, wherein the surface modified synthetic mica comprises a color appearance selected from a group consisting of silver, gold, red, blue, green, bronze, copper, and russet depending on a thickness of the first metallic-appearing coating, and wherein the thickness of the first metallic-appearing coating is about 10-160 nm.

6. The electronic device housing of claim 1, wherein the surface modified glass platelet comprises a fine glass platelet coated with a second metallic-appearing coating, wherein the second metallic-appearing coating is selected from a group consisting of titanium dioxide, silica, and tin oxide, and wherein the second metallic-appearing coating has a thickness of about 10-160 nm.

7. An electronic device, comprising;
at least one antenna; and
a housing to house the at least one antenna, wherein the housing comprises:
a substrate; and
at least one waterborne metallic paint coating formed on a surface of the substrate to allow transmission and/or reception of antenna signals, wherein the waterborne metallic paint coating comprises an insulating material encapsulated metal powder in combination with at least one of a surface modified synthetic mica and a surface modified glass platelet.

8. The electronic device of claim 7, wherein the insulating material comprises at least one of polymer resin and silicon dioxide, wherein the metal powder comprises aluminum flakes, wherein the surface modified synthetic mica comprises a synthetic mica coated with at least one of titanium dioxide and iron oxide, and wherein the surface modified glass platelet comprises a fine glass platelet coated with at least one of titanium dioxide, silica, and tin oxide.

9. The electronic device of claim 7, further comprising at least one intermediate coating formed between the substrate and the at least one waterborne metallic paint coating, wherein the at least one intermediate coating is selected from a group consisting of a waterborne primer coat, a powder coat, a micro-arc oxidation (MAO) layer, and a passive layer.

10. The electronic device of claim 7, wherein each of the at least one intermediate coating has a thickness of about 50 nm-60 μm depending on a type of the at least one intermediate coating.

11. The electronic device of claim 7, further comprising a waterborne clear top coating formed on the at least one waterborne metallic paint coating.

12. A method for manufacturing an electronic device housing, comprising:
providing a substrate; and
coating at least one waterborne metallic paint on a surface of the substrate, wherein the waterborne metallic paint is formed of an insulating material encapsulated metal powder in combination with at least one of a surface modified synthetic mica and a surface modified glass platelet.

13. The method of claim 12, comprising:
prior to coating the at least one waterborne metallic paint on the surface of the substrate, coating the surface of the substrate with one of a waterborne primer coat, a powder coat, a micro-arc oxidation (MAO) layer, and a passive layer.

14. The method of claim 12, comprising:
prior to coating the at least one waterborne metallic paint on the surface of the substrate:
forming a micro-arc oxidation (MAO) layer on the surface of the substrate; and
coating a waterborne primer on the formed MAO layer of the substrate.

15. The method of claim 12, comprising:
prior to coating the at least one waterborne metallic paint on the surface of the substrate:
forming a passive layer on the surface of the substrate; and
coating a waterborne primer on the formed passive layer of the substrate.
